(19) United States
(12) Patent Application Publication
(10) Pub. No.: US 2007/0269181 A1
(43) Pub. Date: Nov. 22, 2007

(54) DEVICE AND METHOD FOR MPEG VIDEO PLAYBACK

(75) Inventor: Yusuke KIKUCHI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/748,093

(22) Filed: May 14, 2007

(30) Foreign Application Priority Data
May 17, 2006 (JP) 2006-137848

(51) Int. Cl. H04N 5/91

(52) U.S. Cl. 386/68

(57) ABSTRACT

An MPEG video playback device for playing back MPEG video streams in the reverse direction, the playback device including MPEG video decoding devices including: a stream buffer configured to have a capacity to store MPEG video streams; an MPEG video stream decoding unit; and frame buffers for receiving picture data; wherein the plurality of MPEG video decoding devices can perform single-speed forward playback; and the stream buffer can be referenced from all of the MPEG video stream decoding units in the MPEG video decoding devices, and the MPEG video stream decoding units can reference and write in all of the frame buffers, and the reverse playback of the MPEG video streams is performed by the MPEG video stream decoding units through decoding two sequential GOPs of the MPEG video stream in parallel and by the MPEG video stream decoding units through referencing the stream buffer and the frame buffers.

### CROSS-REFERENCE TO RELATED APPLICATION

This application is based upon and claims the benefit of priority from the prior Japanese Patent Application No. 2006-137848 filed on May 17, 2006; the entire contents of which are incorporated herein by reference.

### BACKGROUND OF THE INVENTION

1. Field of the Invention

The present invention relates to a device and a method for image playback, and particularly to a device and a method for MPEG video playback with a reverse playback mechanism.

2. Description of Related Art

A function of playing back moving images in the reverse direction is a very effective function when a user uses a search or cue function to find an image. In order to apply the reverse playback to such uses, it is strongly desired that the playback is performed smoothly.

For a P (Predictive) picture and a B (Bidirectionally Predictive) picture used in moving image coding techniques according to the MPEG1 or MPEG2, the amount of information is reduced using differences from past pictures. In the configuration assuming that decoding is performed in the forward direction, future pictures are first decoded in the display sequence when the playback is performed in the reverse direction. Particularly, when there are many P pictures, smooth decoding is difficult since many P pictures need to be decoded before the last P picture in a GOP (Group of Pictures) is decoded.

The known reverse playback methods have drawbacks in, for example, smooth display and high requirement for a memory or the processing speed, making it difficult to realize the methods in an inexpensive MPEG video decoding device. The drawbacks include the following examples:

A method of decoding and displaying only I (Intra) pictures is not appropriate to uses other than fast reversal, since the number of pictures that can be displayed is extremely small.

A method of previously decoding all pictures in a GOP and storing the pictures in a frame buffer to sequentially display the pictures suffers from enormous memory consumption. A method of degrading the resolution of previously decoded pictures and storing the pictures in a frame buffer has a problem in that frequent scaling of the pictures causes deterioration of the quality of processed pictures (see Japanese Patent Laid-Open No. 2004-364211, for example).

A method of decoding reference images one by one as necessary needs to input streams repetitively. Even if the streams are buffered, a fully high decoding speed is required to decode the reference images for many times.

A method of recoding P pictures and transforming the pictures into B pictures or I pictures needs a coding device in addition to a decoding device, resulting in deteriorated images due to the recoding.

### BRIEF SUMMARY OF THE INVENTION

According to one aspect of the present invention, an MPEG video playback device configured to play back MPEG video streams in the reverse direction is provided, the playback device including a plurality of MPEG video decoding devices including: (a) a stream buffer configured to have a capacity to store a GOP of MPEG video streams; (b) an MPEG video stream decoding unit configured to receive and decode the MPEG video streams from the stream buffer; and (c) frame buffers configured to receive the decoded picture data from the MPEG video stream decoding unit; wherein (d) the plurality of MPEG video decoding devices can perform single-speed forward playback; and (e) the stream buffer can be referenced from all of the MPEG video stream decoding units in the plurality of MPEG video decoding devices, and the MPEG video stream decoding units can reference and write in all of the frame buffers in the plurality of MPEG video decoding devices, and (f) the reverse playback of the MPEG video streams is performed by the MPEG video stream decoding units through decoding two sequential GOPs of the MPEG video streams in parallel and by the MPEG video stream decoding units through referencing the stream buffer and the frame buffers.

According to another aspect of the present invention, an MPEG video playback device configured to decode intermittent portions of MPEG video streams in parallel is provided, the playback device including a plurality of MPEG video decoding devices including: (a) a stream buffer configured to have a capacity to store a GOP of MPEG video streams; (b) an MPEG video stream decoding unit configured to receive and decode the MPEG video streams from the stream buffer; and (c) frame buffers configured to receive the decoded picture data from the MPEG video stream decoding unit; wherein (d) the plurality of MPEG video decoding devices can perform single-speed forward playback; and (e) the MPEG video stream decoding units can perform the decoding faster than a single-speed forward playback speed, and the parallel decoding of the intermittent portions of the MPEG video streams is performed by time-shared decoding.

According to still another aspect of the present invention, an MPEG video playback method is provided that includes the steps of: (a) inputting a GOP of MPEG video streams including a playback starting position to a first stream buffer; (b) inputting a GOP of MPEG video streams to be displayed to a second stream buffer; (c) decoding the MPEG video streams by a first MPEG video stream decoding unit as scheduled; (d) decoding the MPEG video streams by a second MPEG video stream decoding unit as scheduled; (e) repeating the processing until all picture data contained in the first stream buffer are decoded if all the picture data contained in the first stream buffer have not been decoded; and (f) decoding all the picture data contained in the first stream buffer, and moving contents of the second stream buffer to the first stream buffer when the first stream buffer is empty.

### BRIEF DESCRIPTION OF THE DRAWINGS

FIG. 1 is a diagram of the schematic block configuration of an MPEG video playback device according to a first embodiment of the present invention;

FIG. 2 is a diagram showing an example of scheduling of reverse playback when pictures in a GOP are configured to be “BBIBBPBBPBBPBBP” in the forward display sequence in the MPEG video playback device according to the first embodiment of the present invention;

FIG. 3 is a flowchart of reverse playback illustrating a playback method for the MPEG video playback device according to the first embodiment of the present invention;

FIG. 4 is a diagram of the schematic block configuration of an MPEG video playback device according to a second embodiment of the present invention; and

FIG. 5 is a diagram showing an example of scheduling of reverse playback when pictures in a GOP are configured to be “IPPPPPPPPPPPPPPP” in the forward display sequence in the MPEG video playback device according to the third embodiment of the present invention.

### DETAILED DESCRIPTION OF THE EMBODIMENTS OF THE INVENTION

Next, embodiments of the present invention will be described with reference to the drawings. In the following description of the drawings, the same or similar portions are given the same or similar symbols.

The following embodiments illustrate devices or methods to embody technical ideas of the present invention. The technical ideas of the present invention do not limit the arrangement of block components and the like as described in the following. Various changes can be made to the technical ideas of the present invention as in the claims.

### First Embodiment

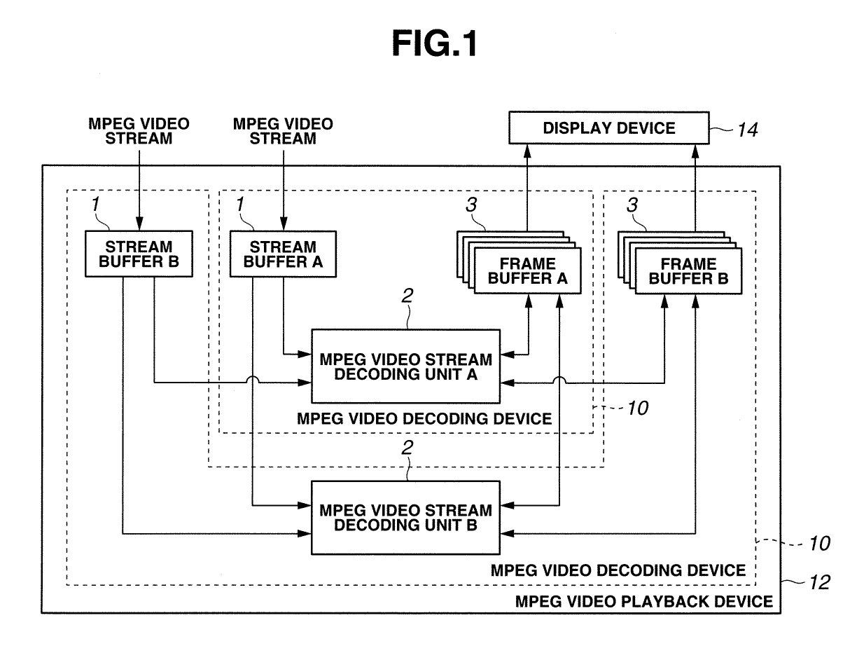

An MPEG video playback device 12 according to a first embodiment of the present invention is configured to play back MPEG video streams in the reverse direction, the playback device including, as shown in FIG. 1, a plurality of MPEG video decoding devices 10 including: a stream buffer 1 configured to have a capacity to store a GOP of MPEG video streams; an MPEG video stream decoding unit 2 configured to receive and decode the MPEG video streams from the stream buffer 1; and frame buffers 3 configured to receive the decoded picture data from the MPEG video stream decoding unit 2; wherein the plurality of MPEG video decoding devices 10 can perform the playback in the forward direction at a single speed; and the stream buffer 1 can be referenced from all the MPEG video stream decoding units 2 in the plurality of MPEG video decoding devices 10, and the MPEG video stream decoding units 2 can reference and write in all the frame buffers 3 in the plurality of MPEG video decoding devices 10, and the reverse playback of the MPEG video streams is performed by the MPEG video stream decoding units 2 through decoding two sequential GOPs of MPEG video streams in parallel and by the MPEG video stream decoding units 2 through referencing the stream buffer 1 and the frame buffers 3.

Alternatively, the MPEG video playback device 12 according to the first embodiment of the present invention operates some of the MPEG video stream decoding units 2 in the plurality of MPEG video decoding devices 10 simultaneously, thereby decoding intermittent portions of MPEG video streams in parallel.

Alternatively, in the MPEG video playback device 12 according to the first embodiment of the present invention, some of the MPEG video stream decoding units 2 in the plurality of MPEG video decoding devices 10 operate simultaneously in the reverse playback to play back an MPEG video stream, but can play back a plurality of MPEG video streams individually and simultaneously in the forward playback.

The MPEG video playback device 12 according to the first embodiment of the present invention includes, as shown in FIG. 1, two MPEG video decoding devices 10, which include, as a whole, a plurality of STD buffers (System Target Decoder Buffers) (hereinafter referred to as stream buffers) 1, a plurality of MPEG video stream decoding units 2 and a plurality of frame buffers 3. An MPEG video decoding device 10 includes a stream buffer 1, an MPEG video stream decoding unit 2 and a frame buffer 3.

In the MPEG video playback device 12 shown in FIG. 1, an MPEG video stream decoding unit A2 and an MPEG video stream decoding unit B2 decode MPEG video streams inputted to stream buffers A1 and B1, output the decoded picture data to a frame buffer A3 and a frame buffer B3, and as a result, transfer the decoded picture data to a display device 14.

The stream buffer 1 is a memory area configured to accumulate input data being MPEG video streams. The MPEG video stream decoding units 2 operate at the speed to be able to play back MPEG video streams in the forward direction in single speed. In other words, the decoding units 2 have the capability to decode data of a picture during a frame time. The frame buffer 3 is a memory area configured to store the decoded picture data. The frame buffer 3 has the data memory capacity corresponding to four pictures, because a capacity for a picture is to store the result of decoding, a capacity for two pictures is to store the previous and the next reference images in decoding MPEG video streams, in addition, a capacity for a picture is generally to retain contents of a decoded image to display the image for a frame time.

In the MPEG video playback device 12 according to the first embodiment of the present invention, as shown in FIG. 1, both the stream buffer 1 and the frame buffers 3 can be read and written by the two MPEG video decoding devices 10.

### (Example of Scheduling Reverse Playback)

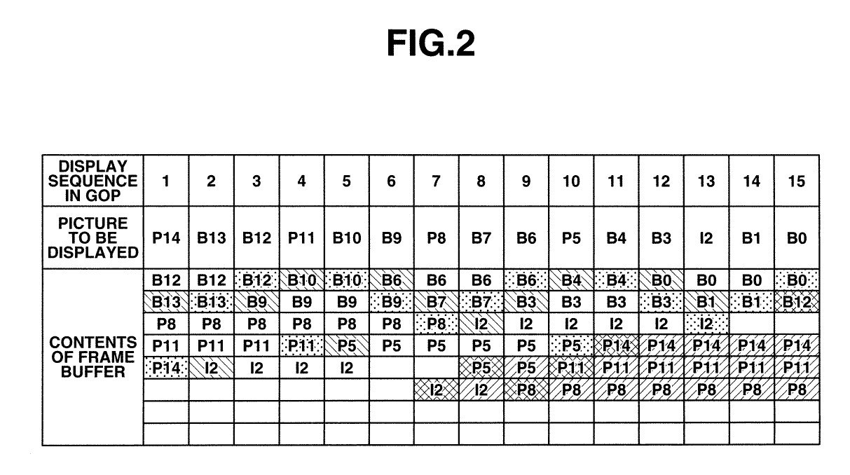

With reference to FIG. 2, an example of scheduling reverse playback will be described in the case that picture in a GOP is configured to be “BBIBBPBBPBBPBBP” in the forward display sequence.

Each column represents a frame time in the GOP. As a column moves to the next (right) column, the time proceeds by a frame. Contents of the frame buffers 3 at the time are written in boxes of the contents of frame buffers. Picture data is represented by a type (I, P or B) and numbers (starting from 0) indicating the display sequence. Each box with a background of lower left to upper right hatching represents a picture belonging to the next GOP in the display sequence. Each picture is decoded at a time written in a box with a background of lower right to upper left hatching, and displayed at a time written in a box with a background of dots. In the drawing, cross hatching indicates that a picture belonging to the next GOP in the display sequence is decoded.

FIG. 2 shows an example of the scheduling to realize the reverse playback using the two MPEG video decoding devices 10 in the MPEG video playback device 12 according to the first embodiment of the present invention.

The lateral axis represents time. As the table moves to the next right box, the time proceeds by a frame. Each row represents each of banks in the frame buffer 3. In the configuration of the MPEG video playback device 12 according to the first embodiment of the present invention, the frame buffer 3 of eight banks is available. In the example shown in FIG. 2, however, only six banks are used.

A picture is represented by an initial letter of its type (I picture, P picture or B picture) and the display sequence for the forward playback in a GOP. In the example shown in FIG. 2, the display sequence is numbered from 0. In the example shown in FIG. 2, the GOP consists of 15 pictures, which are numbered B0, B1, I2, B3, B4, P5, . . . , B13 and P14 in the display sequence.

General constraints on the MPEG video decoding device 10 or the display device 14 require that decoding of picture data in the frame buffer 3 should be finished before the frame buffer 3 is displayed and referenced. Further, the frame buffer 3 cannot be overwritten during the period of the frame being displayed or referenced.

In the example in FIG. 2, timing of the decoding is represented by a time written in each box with the background of lower right to upper left hatching, while timing of the displaying is represented by a time written in each box with the background of dots. Each box with the background of lower left to upper right hatching represents a picture in the next displayed GOP (the previous GOP to the current displayed GOP along the streaming time axis).

When the last frame time in a GOP passes, the sequence returns to the left end of the table to start decoding and displaying the next GOP. The contents of the frame buffer 3 are inherited when the next GOP is displayed, so that the column on the left end of the table inherits picture data of the next GOP stored in the frame buffer 3 at the column on the right end of the table. The picture data of the next displayed GOP is decoded and some of the pictures are retained, such that continuous reverse playback is possible even immediately after switching a GOP.

### (Method of Reverse Playback)

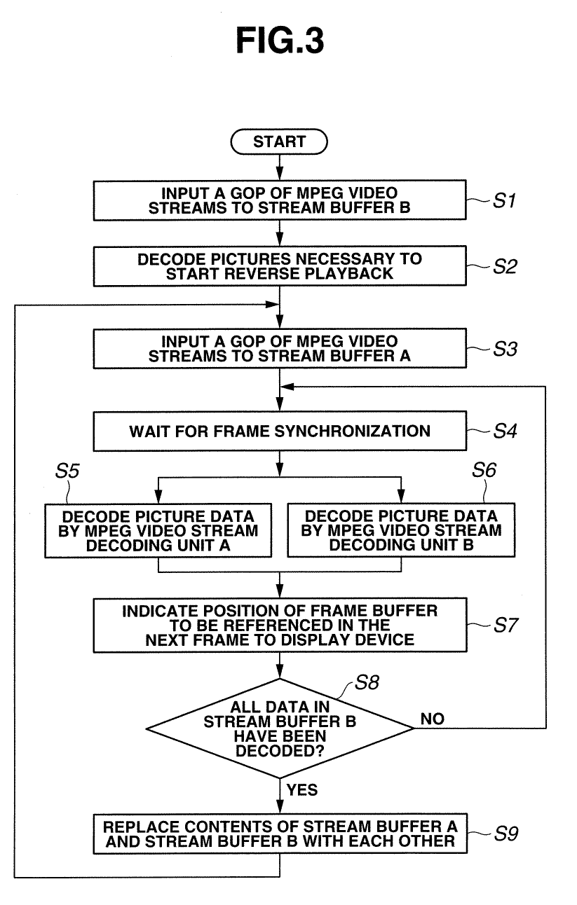

A method of reverse playback by the MPEG video playback device 12 according to the first embodiment of the present invention will be described using a flowchart of the reverse playback shown in FIG. 3. The processing can be described as follows:

(a) First, at step S1, input a GOP of MPEG video streams including a playback starting position to a stream buffer B1.

(b) Next, at step S2, to start the reverse playback, decode picture data such that the contents of the frame buffer 3 are in the state of the left end of the table for the scheduling shown in FIG. 2.

Also in the reverse playback, predictive coded data needs to be decoded in arranging order of streams. For example, to decode a B3 picture in FIG. 2, the preceding I2 and P5 pictures need to be decoded as the reference images.

For this purpose, to set the contents of the frame buffer 3 to the state of the left end of the table for the scheduling shown in FIG. 2, during the previous GOP period in the display sequence, for example during the seventh frame period in the display sequence in the GOP in the example in FIG. 2, the I2 picture indicated by the lower left to upper right hatching in FIG. 2 is decoded. As shown in FIG. 2, in the following frame periods, the P5 picture is decoded using the I2 picture and a P8 picture is decoded using the P5 picture. Afterward, only the reference images are decoded similarly, decoded data of pictures P8, P11 and P14 is saved in the frame buffer 3 by the eleventh frame period in the display sequence in the GOP. In this way, during the first frame period in the display sequence in the GOP, decoded data of pictures P8, P11, P14 and B12 is saved in the frame buffer 3.

(c) Next, at step S3, input a GOP of MPEG video streams to be displayed next to a stream buffer A1.

(d) Next, at step S4, synchronize the frames before starting to decode.

(e) Next, at step S5, decode picture data by an MPEG video stream decoding unit A2 as scheduled.

(f) Next, at step S6, decode the picture data by an MPEG video stream decoding unit B2 as scheduled.

(g) Next, at step S7, after the decoding ends, if there is picture data that can be displayed, indicate a bank in the frame buffer 3 to be referenced to the display device 14.

For example, during the first frame period in the display sequence in the GOP, the decoded data of the picture P14 retained in the frame buffer 3 is outputted for display (dotted part), and coded data of a picture B13 is read out from the stream buffer 1 for the decoding processing (lower right to upper left hatching part).

During the next (second) frame period in the display sequence in the GOP, decoded data of a picture B13 retained in the frame buffer 3 is outputted for display (dotted part), and coded data of the picture 12 is read out from the stream buffer 1 for the decoding processing (lower right to upper left hatching part). Afterward, the decoding processing is performed similarly as scheduled in FIG. 2.

As described above, during the seventh frame period in the display sequence in the GOP, decoded data of a picture B7 retained in the frame buffer 3 is outputted for display (dotted part), and coded data of the picture I2 during the next GOP period in the display sequence is read out from the stream buffer 1 for the decoding processing (lower right to upper left hatching part).

In the processing, during frame periods after the seventh one in the display sequence in the GOP, different pictures are read out from the two frame buffers 1, and decoded by the two MPEG video stream decoding units 2 in parallel. Although the flowchart describes that data of two pictures is decoded during a frame time, the processing can apply to faster reverse playback by decoding more pictures.

(h) Next, at step S8, determine whether or not all the picture data contained in the stream buffer B1 have been decoded; if NO, then return to the frame synchronization waiting state at step S4, and repeat the processing until all the picture data contained in the stream buffer B1 are decoded; if YES, then proceed to step S9.

(i) Next, at step S9, move contents of the stream buffer A1 to the stream buffer B1 when the stream buffer B1 is empty. Then, return to the processing at step S3 to continue the playback.

In this way, according to the embodiment of the present invention, two pictures can be decoded during a frame period and a frame buffer is used that can store six frames of decoded data, so that necessary reference images can be ensured to be retained in a frame buffer at the reverse playback. This enables smooth reverse playback by continuous decoding processing. Further, a plurality of MPEG video stream decoding units can decode two pictures during a frame period. Furthermore, even an MPEG video playback device without the decoding speed or the memory capacity designed for the reverse playback can perform smooth reverse playback.

Although the above description refers to the MPEG video playback device 12 according to the first embodiment of the present invention including the two MPEG video decoding devices 10, a playback device 12 including more decoding devices 10 can also operate similarly.

As in the MPEG video playback device according to the first embodiment of the present invention, even an MPEG video playback device without the decoding speed or the memory capacity designed for the reverse playback can perform smooth reverse playback.

As in the MPEG video playback device according to me first embodiment of the present invention, the device is configured to be equipped with the plurality of MPEG video stream decoding units 2 to play back a plurality of MPEG video streams simultaneously, so that added value of the reverse playback function can be given without any additional special hardware.

The MPEG video playback device according to the first embodiment of the present invention can selectively use a reverse playback function for an MPEG video stream or a simultaneous playback function for a plurality of video streams. For example, a digital television that can normally perform playback on two displays simultaneously can be functionally switched into a device that can perform the reverse playback on a display.

### Second Embodiment

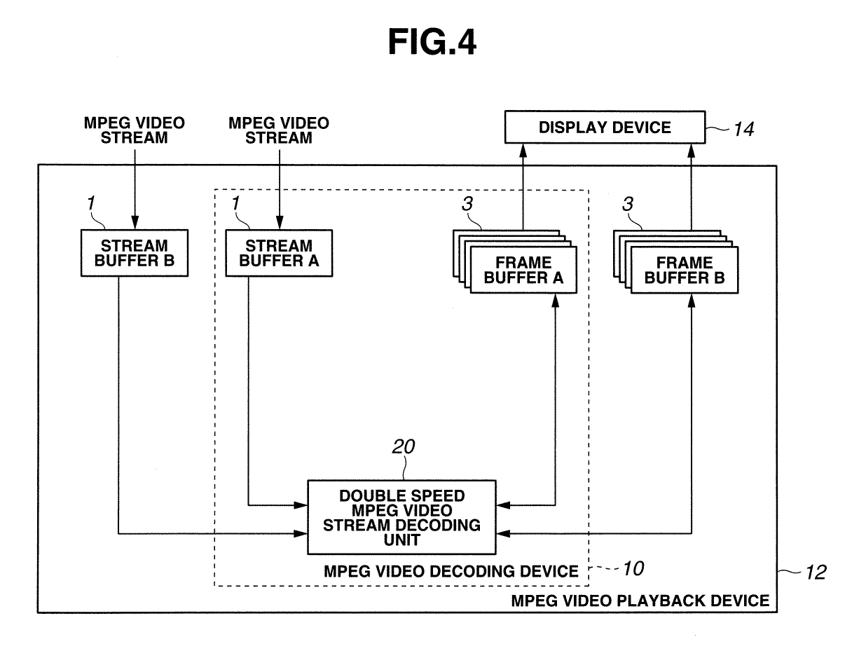

An MPEG video playback device 12 according to a second embodiment of the present invention includes, as shown in FIG. 4, a plurality of MPEG video decoding devices 10 including: a stream buffer 1 configured to have a capacity to store a GOP of MPEG video streams; a double-speed MPEG video stream decoding unit 20 configured to receive and decode the MPEG video streams from the stream buffer 1; and frame buffers 3 configured to receive the decoded picture data from the double-speed MPEG video stream decoding unit 20; wherein the plurality of MPEG video decoding devices 10 can perform single-speed forward playback; and the double-speed MPEG video stream decoding unit 20 can perform the decoding faster than the single-speed forward playback speed and decode intermittent portions of MPEG video streams in parallel by time-shared decoding.

Alternatively, in the MPEG video playback device 12 according to the second embodiment of the present invention, some of the double-speed MPEG video stream decoding units 20 in the plurality of MPEG video decoding devices 10 operate simultaneously in the reverse playback to play back an MPEG video stream, but can play back a plurality of MPEG video streams individually and simultaneously in the forward playback.

Alternatively, in the MPEG video playback device 12 according to the second embodiment of the present invention, some of the double-speed MPEG video stream decoding units 20 in the plurality of MPEG video decoding devices 10 operate simultaneously in the reverse playback to play back an MPEG video stream by the time-shared processing, but can play back a plurality of MPEG video streams individually and simultaneously in the forward playback.

The MPEG video playback device 12 according to the second embodiment of the present invention includes an MPEG video decoding device 10 that can perform decoding at double speed as shown in FIG. 4. The playback device 12 and the decoding device 10 include, as a whole, a plurality of stream buffers 1, the double-speed MPEG video stream decoding unit 20 that can perform decoding at double speed and a plurality of frame buffers 3. The MPEG video decoding device 10 includes a stream buffer 1, a double-speed MPEG video stream decoding unit 20 and a frame buffer 3.

In the MPEG video playback device 12 shown in FIG. 4, the double-speed MPEG video stream decoding unit 20 decodes MPEG video streams inputted to the stream buffer 1, outputs the picture data to the frame buffers 3, and as a result, transfers the data to the display device 14.

The stream buffer 1 is a memory area configured to accumulate input data being MPEG video streams. The double-speed MPEG video stream decoding unit 20 operates at the speed to be able to play back MPEG video streams in the forward direction in double speed. In other words, the decoding unit 2 has the capability to decode data of two pictures during a frame time. The frame buffer 3 is a memory area configured to store the decoded picture data. The frame buffer 3 has the data memory capacity corresponding to four pictures similarly to the MPEG video playback device 12 according to the first embodiment, because a capacity for a picture is to store the result of decoding, a capacity for two pictures is to store the previous and the next reference images in decoding MPEG video streams, in addition, a capacity for a picture is generally to retain contents of a decoded image to display the image for a frame time.

In the MPEG video playback device 12 according to the second embodiment of the present invention, as shown in FIG. 4, both the stream buffer 1 and the frame buffers 3 can be read and written by the double-speed MPEG video stream decoding unit 20.

The MPEG video playback device 12 according to the second embodiment of the present invention includes the double-speed MPEG video stream decoding unit 20 that can perform decoding at double speed for the configuration of an MPEG video playback device, as shown in FIG. 4. The double-speed MPEG video stream decoding unit 20 can decode two pictures during a frame time, and can perform the reverse playback operation similarly to the MPEG video playback device 12 according to the first embodiment of the present invention.

Using the MPEG video playback device 12 according to the second embodiment of the present invention, a high-quality playback result can be obtained with less frame buffer capacity.

Alternatively, the MPEG video playback device 12 according to the second embodiment of the present invention can selectively use a reverse playback function for an MPEG video stream or a simultaneous playback function for a plurality of video streams. For example, a digital television that can normally perform playback on two displays simultaneously can be functionally switched into a device that can perform reverse playback on a display.

### Third Embodiment

An MPEG video playback device 12 according to a third embodiment of the present invention is, similarly to the first embodiment shown in FIG. 1, configured to play back MPEG video streams in the reverse direction, the playback device 12 including a plurality of MPEG video decoding devices 10 including: a stream buffer 1 configured to have a capacity to store a GOP of MPEG video streams; an MPEG video stream decoding unit 2 configured to receive and decode the MPEG video streams from the stream buffer 1; and frame buffers 3 configured to receive the decoded picture data from the MPEG video stream decoding unit 2; wherein the plurality of MPEG video decoding devices 10 can perform the playback in the forward direction at a single speed; and the stream buffer 1 can be referenced from all the MPEG video stream decoding units 2 in the plurality of MPEG video decoding devices 10, and the MPEG video stream decoding units 2 can reference and write in all the frame buffers 3 in the plurality of MPEG video decoding devices 10, and the reverse playback of the MPEG video streams is performed by the MPEG video stream decoding units 2 through decoding two sequential GOPs of MPEG video streams in parallel and by the MPEG video stream decoding units 2 through referencing the stream buffer 1 and the frame buffers 3.

Alternatively, the MPEG video playback device 12 according to the third embodiment of the present invention operates, similarly to the first embodiment shown in FIG. 1, some of the MPEG video stream decoding units 2 in the plurality of MPEG video decoding devices 10 simultaneously, thereby decoding intermittent portions of the MPEG video streams in parallel.

An MPEG video playback device 12 according to the third embodiment of the present invention includes, similarly to the second embodiment shown in FIG. 4, a plurality of MPEG video decoding devices 10 including: a stream buffer 1 configured to have a capacity to store a GOP of MPEG video streams; a double-speed MPEG video stream decoding unit 20 configured to receive and decode the MPEG video streams from the stream buffer 1; and frame buffers 3 configured to receive the decoded picture data from the double-speed MPEG video stream decoding unit 20; wherein the plurality of MPEG video decoding devices 10 can perform the playback in the forward direction at a single speed; and the double-speed MPEG video stream decoding unit 20 can perform the decoding faster than the single-speed forward playback speed and decode intermittent portions of MPEG video streams in parallel by time-shared decoding.

Alternatively, in the MPEG video playback device 12 according to the third embodiment of the present invention, the MPEG video stream decoding units 2 shown in FIG. 1 or the double-speed MPEG video stream decoding unit 20 shown in FIG. 4 decodes a future displayed P picture before the display when playing back MPEG video streams in the reverse direction, stores part of data of the decoded P picture in the plurality of frame buffers 3, discards the remaining P picture data of the decoded P picture data temporarily and regenerates the remainder from the P picture data and I picture data stored in the frame buffers 3 immediately before the display, thereby keeping sequentiality of the display.

Alternatively, in the MPEG video playback device 12 according to the third embodiment of the present invention, some of the MPEG video stream decoding units 2 or the double-speed MPEG video stream decoding units 20 in the plurality of MPEG video decoding devices 10 operate simultaneously in reverse playback to play back an MPEG video stream, but can play back a plurality of MPEG video streams individually and simultaneously in forward playback.

Alternatively, in the MPEG video playback device 12 according to the third embodiment of the present invention, some of the MPEG video stream decoding units 2 or the double-speed MPEG video stream decoding units 20 in the plurality of MPEG video decoding devices 10 operate simultaneously in reverse playback to play back an MPEG video stream by the time-shared processing, but can play back a plurality of MPEG video streams individually and simultaneously in forward playback.

### (Example of Scheduling Reverse Playback)

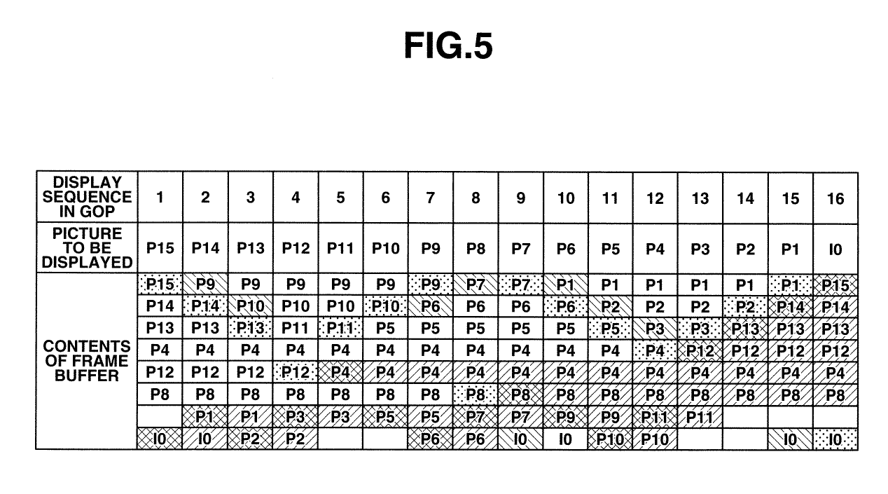

With reference to FIG. 5, an example of scheduling reverse playback will be described in the case that a picture in a GOP is configured to be “IPPPPPPPPPPPPPPP” in forward display sequence, that is, scheduling in an example in which the GOP consists of an I picture and 15 P pictures. Also in this example, smooth reverse playback can be realized using the eight frame buffers 3 and the two MPEG video stream decoding units 2.

In the scheduling, only data of some of P pictures is retained and data of the remaining P pictures is discarded in the process of decoding data of the next displayed P picture in the GOP. The data of the discarded P pictures can be regenerated based on the data of the retained P pictures immediately before being needed for the display, and displayed as an image without suffering deterioration of the quality of picture compared to the normal forward playback. The amount of consumption of the frame buffers 3 is restrained by retaining only the data of some of P pictures.

If the configuration of a GOP does not change in MPEG video streams, picture data can be displayed continuously even at the boundary of the GOP. If the configuration of a GOP changes in MPEG video streams, picture data may be displayed discontinuously.

As in the MPEG video playback device 12 according to the third embodiment of the present invention, in a GOP configured such that all pictures other than an I picture is P pictures, if the GOP contains a B picture being the head of the previous GOP, only the B picture cannot be decoded.

When a picture to be displayed originally cannot be decoded, the previous displayed picture will continue to be displayed. The smoothness of the display is lost temporarily, but can recover as soon as the picture to be displayed can be decoded.

As in the MPEG video playback device 12 according to the third embodiment of the present invention, even an MPEG video playback device without the decoding speed or the memory capacity designed for the reverse playback can realize the smooth reverse playback.

Alternatively, according to the third embodiment of the present invention, the MPEG video playback device 12 is configured to be equipped with the plurality of MPEG video stream decoding units to play back a plurality of MPEG video streams simultaneously, so that added value of the reverse playback function can be given without any additional special hardware.

Alternatively, using the MPEG video playback device 12 according to the third embodiment of the present invention, a high-quality playback result can be obtained with less frame buffer capacity.

Alternatively, with the MPEG video playback device 12 according to the third embodiment of the present invention, the smooth reverse playback can be performed with a frame buffer with a limited capacity. In addition, the performance requirement is low from an MPEG video stream decoding unit needed to decode a P picture, so the requirement can be fulfilled with a decoding speed corresponding to the two MPEG video stream decoding units having the decoding capability to be able to perform the single-speed forward playback. That is, a very high decoding speed is not requested from an MPEG video stream decoding unit or an enormous capacity is not requested from a frame buffer. The embodiment is tremendously effective particularly when a large number of P pictures are contained in a GOP.

Alternatively, the MPEG video playback device 12 according to the third embodiment of the present invention can selectively use a reverse playback function for an MPEG video stream or a simultaneous playback function for a plurality of video streams. For example, a digital television that can normally perform playback on two displays simultaneously can be functionally switched into a device that can perform the reverse playback on a display.

### Other Embodiments

Although the present invention has been described according to the above embodiments, the statements and drawings being part of the disclosure should not be understood to limit the present invention. Various alternatives, embodiments and their operating techniques will be clear to those skilled in the art from the disclosure.

As noted in the above, the present invention includes, of course, various embodiments or the like not described herein. Consequently, the technical scope of the present invention should be defined only by the invention specifications according to the claims recognized as appropriate from the above description.

According to the above mentioned embodiments, MPEG video streams can be played back smoothly in the reverse direction by operating a plurality of MPEG video decoding units and frame buffers for the plurality of MPEG video decoding units simultaneously and by using the results of the decoding as reference images to one another.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An MPEG video playback device configured to play back MPEG video streams in the reverse direction, the playback device comprising a plurality of MPEG video decoding devices comprising:
a stream buffer configured to have a capacity to store a GOP of MPEG video streams;
an MPEG video stream decoding unit configured to receive and decode the MPEG video streams from said stream buffer; and
frame buffers configured to receive the decoded picture data from said MPEG video stream decoding unit;
wherein the plurality of MPEG video decoding devices can perform single-speed forward playback; and
said stream buffer can be referenced from all of said MPEG video stream decoding units in said plurality of MPEG video decoding devices, and said MPEG video stream decoding units can reference and write in all of said frame buffers in said plurality of MPEG video decoding devices, and
the reverse playback of said MPEG video streams is performed by said MPEG video stream decoding units through decoding two sequential GOPs of said MPEG video streams in parallel and by said MPEG video stream decoding units through referencing said stream buffer and said frame buffers.

2. The MPEG video playback device according to claim 1 configured to decode intermittent portions of said MPEG video streams in parallel by operating said plurality of MPEG video stream decoding units in said plurality of MPEG video decoding devices simultaneously.

3. The MPEG video playback device according to claim 1 configured to decode a first GOP of said MPEG video streams by said MPEG video stream decoding unit included in a first MPEG video decoding device of said plurality of MPEG video decoding devices, and decode said first GOP and a following second GOP by said MPEG video stream decoding unit included in a second MPEG video decoding device of said plurality of MPEG video decoding devices.

4. The MPEG video playback device according to claim 3 configured to perform the decoding of said first GOP by said first MPEG video decoding device and the decoding of said second GOP by said second MPEG video decoding device simultaneously in parallel.

5. The MPEG video playback device according to claim 1, wherein said MPEG video stream decoding unit decodes a future displayed P picture before being displayed when playing back said MPEG video streams in the reverse direction, store part of said decoded I and P picture data in said plurality of frame buffers, discard remaining I and P picture data of said decoded I and P picture data temporarily and regenerate the discarded data from the P picture data or I picture data stored in said frame buffers immediately before being displayed, thereby keeping sequentiality of the display.

6. The MPEG video playback device according to claim 2, wherein said MPEG video stream decoding unit decodes a future displayed P picture before being displayed when playing back said MPEG video streams in the reverse direction, store part of said decoded I and P picture data in said plurality of frame buffers, discard remaining I and P picture data of said decoded I and P picture data temporarily and regenerate the discarded data from the P picture data or I picture data stored in said frame buffers immediately before being displayed, thereby keeping sequentiality of the display.

7. The MPEG video playback device according to claim 3, wherein said MPEG video stream decoding unit decodes a future displayed P picture before being displayed when playing back said MPEG video streams in the reverse direction, store part of said decoded I and P picture data in said plurality of frame buffers, discard remaining I and P picture data of said decoded I and P picture data temporarily and regenerate the discarded data from the P picture data or I picture data stored in said frame buffers immediately before being displayed, thereby keeping sequentiality of the display.

8. The MPEG video playback device according to claim 4, wherein said MPEG video stream decoding unit decodes a future displayed P picture before being displayed when playing back said MPEG video streams in the reverse direction, store part of said decoded I and P picture data in said plurality of frame buffers, discard remaining I and P picture data of said decoded I and P picture data temporarily and regenerate the discarded data from the P picture data or I picture data stored in said frame buffers immediately before being displayed, thereby keeping sequentiality of the display.

9. An MPEG video playback device configured to decode intermittent portions of MPEG video streams in parallel, the playback device comprising a plurality of MPEG video decoding devices comprising:
a stream buffer configured to have a capacity to store a GOP of MPEG video streams;
an MPEG video stream decoding unit configured to receive and decode the MPEG video streams from said stream buffer; and
frame buffers configured to receive the decoded picture data from said MPEG video stream decoding unit;
wherein the plurality of MPEG video decoding devices can perform single-speed forward playback; and
said MPEG video stream decoding units can perform the decoding faster than a single-speed forward playback speed, and the parallel decoding of the intermittent portions of the MPEG video streams is performed by time-shared decoding.

10. The MPEG video playback device according to claim 9 configured to decode intermittent portions of said MPEG video streams in parallel by operating said plurality of MPEG video stream decoding units in said plurality of MPEG video decoding devices simultaneously.

11. The MPEG video playback device according to claim 9 configured to decode a first GOP of said MPEG video streams by said MPEG video stream decoding unit included in a first MPEG video decoding device of said plurality of MPEG video decoding devices, and decode said first GOP and a following second GOP by said MPEG video stream decoding unit included in a second MPEG video decoding device of said plurality of MPEG video decoding devices.

12. The MPEG video playback device according to claim 11 configured to perform the decoding of said first GOP by said first MPEG video decoding device and the decoding of said second GOP by said second MPEG video decoding device simultaneously in parallel.

13. The MPEG video playback device according to claim 9, wherein said MPEG video stream decoding unit can perform the decoding at double the speed as the single-speed forward playback speed.

14. The MPEG video playback device according to claim 11, wherein said first and second GOPs are configured only by I pictures and P pictures.

15. The MPEG video playback device according to claim 9, wherein said MPEG video stream decoding unit decodes a future displayed P picture before being displayed when playing back said MPEG video streams in the reverse direction, stores part of said decoded I and P picture data in said plurality of frame buffers, discards remaining I and P picture data of said decoded I and P picture data temporarily and regenerates the discarded data from the P picture data or I picture data stored in said frame buffers immediately before being displayed, thereby keeping sequentiality of the display.

16. The MPEG video playback device according to claim 10, wherein said MPEG video stream decoding unit decodes a future displayed P picture before being displayed when playing back said MPEG video streams in the reverse direction, stores part of said decoded I and P picture data in said plurality of frame buffers, discards remaining I and P picture data of said decoded I and P picture data temporarily and regenerates the discarded data from the P picture data or I picture data stored in said frame buffers immediately before being displayed, thereby keeping sequentiality of the display.

17. The MPEG video playback device according to claim 11, wherein said MPEG video stream decoding unit decodes a future displayed P picture before being displayed when playing back said MPEG video streams in the reverse direction, stores part of said decoded I and P picture data in said plurality of frame buffers, discards remaining I and P picture data of said decoded I and P picture data temporarily and regenerates the discarded data from the P picture data or I picture data stored in said frame buffers immediately before being displayed, thereby keeping sequentiality of the display.

18. The MPEG video playback device according to claim 13, wherein said MPEG video stream decoding unit decodes a future displayed P picture before being displayed when playing back said MPEG video streams in the reverse direction, stores part of said decoded I and P picture data in said plurality of frame buffers, discards remaining I and P picture data of said decoded I and P picture data temporarily and regenerates the discarded data from the P picture data or I picture data stored in said frame buffers immediately before being displayed, thereby keeping sequentiality of the display.

19. The MPEG video playback device according to claim 14, wherein said MPEG video stream decoding unit decodes a future displayed P picture before being displayed when playing back said MPEG video streams in the reverse direction, stores part of said decoded I and P picture data in said plurality of frame buffers, discards remaining I and P picture data of said decoded I and P picture data temporarily and regenerates the discarded data from the P picture data or I picture data stored in said frame buffers immediately before being displayed, thereby keeping sequentiality of the display.

20. An MPEG video playback method comprising:
inputting a GOP of MPEG video streams including a playback starting position to a first stream buffer;
inputting a GOP of MPEG video streams to be displayed to a second stream buffer;
decoding said MPEG video streams by a first MPEG video stream decoding unit as scheduled;
decoding said MPEG video streams by a second MPEG video stream decoding unit as scheduled;
repeating the processing until all picture data contained in said first stream buffer are decoded if all the picture data contained in said first stream buffer have not been decoded; and
decoding all the picture data contained in said first stream buffer, and moving contents of said second stream buffer to said first stream buffer when said first stream buffer is empty.
